(19) United States
(12) Patent Application Publication
(10) Pub. No.: US 2025/0224813 A1
(43) Pub. Date: Jul. 10, 2025

(54) UNIBODY KEYBOARD CASE FOR MOBILE DEVICES

(71) Applicant: Clicks Technology Ltd., London (GB)

(72) Inventors: Adrian Li Mow CHING, London (GB); Liangchen CHEN, Guildford (GB); Kevin MICHALUK, Manatoba (CA)

(73) Assignee: Clicks Technology Ltd., London (GB)

(21) Appl. No.: 19/011,240

(22) Filed: Jan. 6, 2025

Related U.S. Application Data
(60) Provisional application No. 63/617,499, filed on Jan. 4, 2024.

(30) Foreign Application Priority Data
Jan. 4, 2024 (GB) 2400131.5

(51) Int. Cl. G06F 3/02; G06F 3/023; H04M 1/21

(52) U.S. Cl. CPC G06F 3/0202; G06F 3/023; H04M 1/21

(57) ABSTRACT

A device for adding a keyboard to a mobile device may include an outer shell. An open recess may be provided in the outer shell for insertion of the mobile device. A keyboard may be attached to the outer shell. The outer shell may be of a unibody single-piece construction.

This application claims priority under 35 USC § 119 (e) from U.S. provisional patent application No. 63/617,499, which was filed on 4th January 2024, the entire contents of which are incorporated herein by reference.

This application claims priority under 35 USC § 119 (a)-(d) to United Kingdom Patent Application No. GB2400131.5, which was filed on 4th January 2024, the entire contents of which are incorporated herein by reference.

### BACKGROUND

### 1. Field

Example embodiments relate in general to accessory devices for mobile devices such as Apple iPhones and other smartphones. More particularly, example embodiments relate to function-enabling attachable mobile device cases that may include additional keyboard buttons which are capable of facilitating user interactions with a physical keyboard for handheld typing and device operation.

### 2. Discussion of Related Art

Mobile device users typically interact with their mobile devices by a combination of gestures and actions, including tapping on and swiping at digital images rendered on touchscreens. In the case of typing on mobile devices, most operating systems require users to tap on a simulated digital keyboard which is displayed on and occupies a portion of the available touchscreen display area on the device. This mechanism for typing creates several limitations and drawbacks.

Firstly, the absence of any physical buttons or other notable physical locating features for the on-screen keys creates difficulty in quickly and precisely locating keys whilst typing, reducing both typing speed and accuracy.

Secondly, all on-screen digital keyboards used for typing on mobile devices occupy a significant proportion of the available screen area, which reduces the portion of the remaining screen area available to display the text being typed or the remainder of the relevant on-screen content, compromising productivity. This reduces the utility of the mobile device more generally whilst typing on an on-screen keyboard, because the screen is able to display less useful content or information.

Thirdly, while some mobile devices have attempted to mitigate some of these shortcomings by providing an artificial haptic or audible feedback response upon the registration of each keystroke on an on-screen keyboard, the user experience whilst typing on such mobile devices remains distinct from the feedback response encountered from traditional physical computer keyboards, as it is less positive, accurate or comfortable to use and therefore inferior.

Additionally, physical keyboard accessories for mobile devices or tablets generally have previously been large, cumbersome, fragile, heavy, complicated and/or considerably less portable than many modern mobile devices, limiting the overall portability of the mobile device when using or carrying such accessories.

Furthermore, modern mobile devices are complicated and delicate electronic devices which often require the attachment of a protective accessory case in order to improve the day-to-day robustness and durability of the device to acceptable levels for consumers.

### SUMMARY

Non-limiting embodiments of the invention seek to resolve the aforementioned shortcomings concerning the use of mobile devices for typing by proposing a new type of protective accessory case that may include a unibody design with an outer case shell and an integrated ‘QWERTY’ keyboard assembly with physical buttons (or keys) to facilitate full use of the device's available screen space whilst typing. The round keys of the device's keyboard may be located below the lower edge of the mobile device screen and may protrude upwards from the front face of the outer shell and may have sufficient key travel to provide a tactile mechanical keystroke response for the user and precise typing. Data communication of the user's entered keystrokes whilst typing may be transmitted to the mobile device via a male electronic connector built into the device. The outer shell containing the keyboard assembly provides physical protection to the device whilst largely retaining the slim profile and shallow depth of the mobile device.

According to non-limiting embodiments, a device for adding a physical keyboard to a mobile device may include an outer shell with an open recess for insertion of the mobile device. A keyboard may be attached to the outer shell. The outer shell itself may be of a unibody single-piece construction.

### BRIEF DESCRIPTION OF THE DRAWINGS

Some embodiments of the present invention are illustrated as an example and are not limited by the figures, in which like references may indicate similar elements, which are given by way of illustration only, and in which:

FIG. 1 is a front view of the device, being a unibody keyboard case for mobile devices, and illustrates the positioning of the outer shell, the device recess for insertion of the mobile device and the keyboard location;

FIG. 2 is a bottom view of the device and demonstrates the location of the female electronic connector in the outer shell;

FIG. 3 is a left side view and demonstrates the protrusion of the keyboard keys from the front face of the outer shell;

FIG. 4 is a right side view and demonstrates the protrusion of the keyboard keys from the front face of the outer shell;

FIG. 5A is a top view of the keyboard showing the layout and arrangement of the keyboard;

FIG. 5B is a left side view of the keyboard showing the layout and arrangement of the keyboard keys, the ride side view being a mirror image thereof;

FIG. 5C is a front view of the keyboard showing the layout and arrangement of the keyboard keys;

FIG. 5D is a perspective view of the keyboard showing the layout and arrangement of the keyboard keys;

FIG. 6 is a perspective view of the keyboard showing the arrangement of the ‘QWERTY’ key face lettering;

FIG. 7 is a front view of the device, showing the location of the male electronic connector in the recess;

FIG. 8 is a front perspective view of the device with a mobile device inserted in the device recess;

FIG. 9 is a rear perspective view of the outer shell showing the keyboard subassembly cavity;

FIG. 10 is a font perspective view of the outer shell showing the device recess;

FIG. 11 is an exploded view of the front of a keyboard subassembly; and

FIG. 12 is an exploded view of the rear of the keyboard subassembly showing how it fits into the outer shell.

### DESCRIPTION OF NON-LIMITING EMBODIMENTS

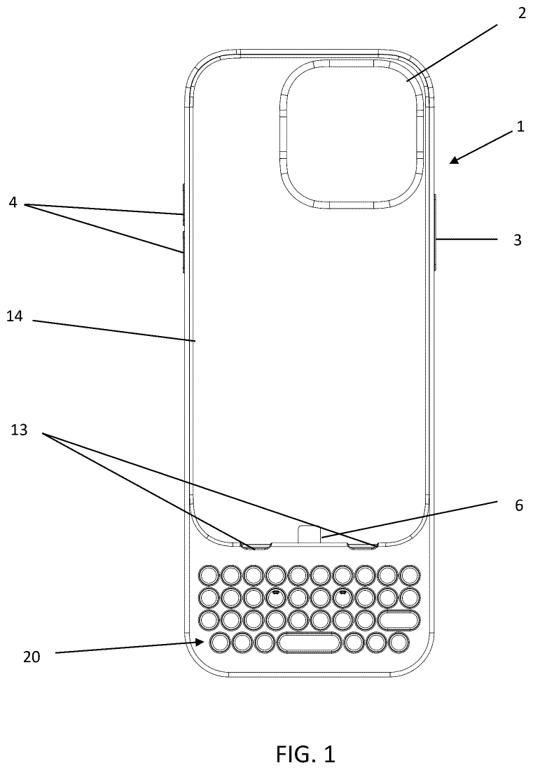

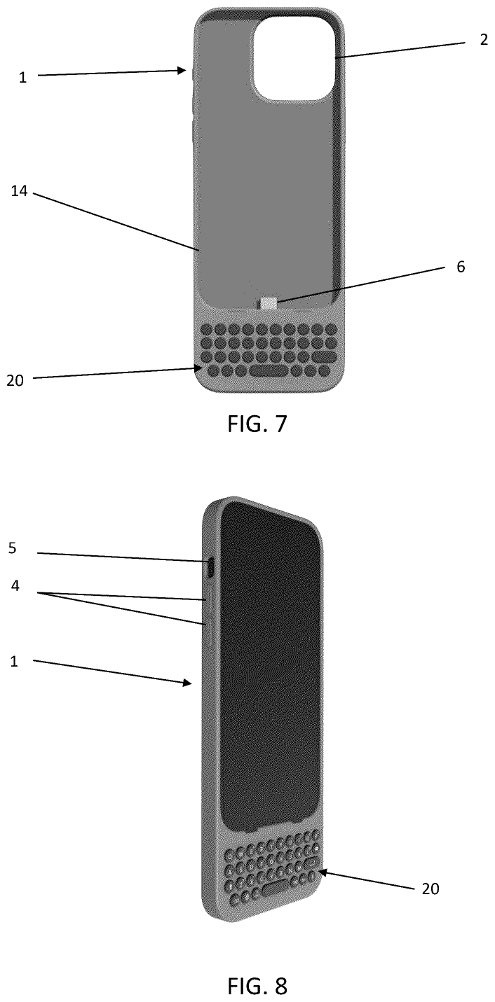

FIG. 1 and FIG. 7 show the frontal view of the device comprising the unibody outer shell 1 shaped to fit a specific mobile device within the device recess 14, with a camera opening 2 to create an aperture for the mobile device's camera lens.

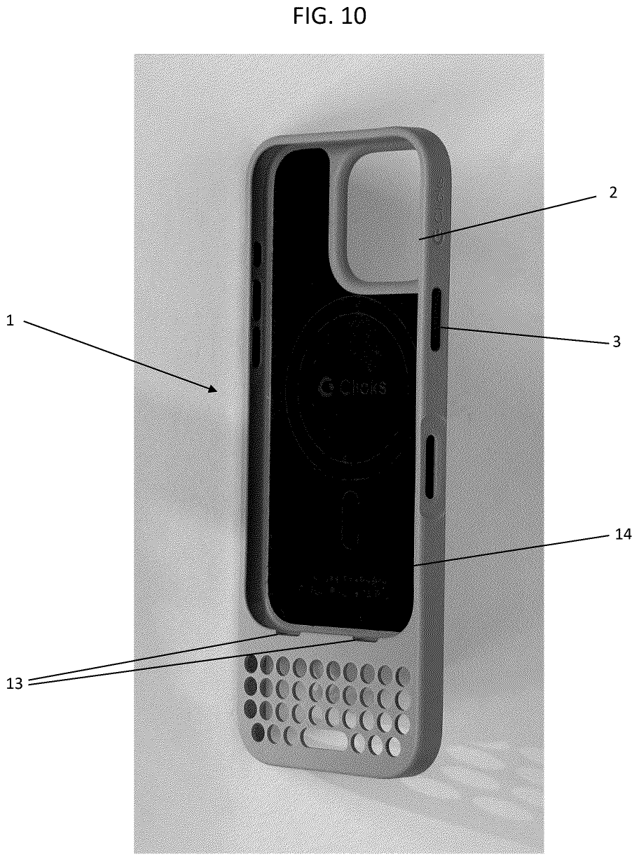

The outer shell 1 shown in FIG. 10 is of a unibody construction, where ‘unibody’ means that it forms a single gapless continuous part, and which may have been manufactured from either a single material by a process such as 3D printing, injection moulding or computer numerical control ‘CNC’ machining, or instead may be formed from multiple parts which may be irreversibly combined but which cannot be disassembled without destroying the part.

The unibody construction of the outer shell 1 described above may provide numerous advantages over alternative constructions. For example, compared with many mobile device cases which consist of multiple pieces, contain moving parts, or which require assembly or disassembly prior to use or removal of the mobile device, the unibody construction may provide the following benefits:
Durability—the unibody construction Is more durable, harder-wearing and provides a longer service life than alternative constructions which can be weaker or more fragile;
Ease of use—the unibody construction makes insertion and removal of mobile devices faster and easier than alternative constructions which can be complicated to assemble and use;
Simplicity—the minimal number of parts, the absence of any moving parts and the lack of screws, clamps or other fasteners reduces the number of possible failure points compared with alternative constructions which have more design features which can fail or become defective;
Impact protection—the unibody case construction has a flexible structure and provides greater impact protection than multi-piece cases which can transfer impact loads and shock directly to the mobile device instead of absorbing them or which can be brittle;
Compactness—unibody cases can be moulded and shaped to fit closely around the mobile device, minimising unnecessary bulk from fasteners and making the device more attractive to consumers;
Lightness—the lack of unnecessary bulk, material or fasteners allows their weight to be kept to a minimum, which is attractive to consumers; and
Low manufacturing cost—unibody cases are often less expensive to produce than alternative designs.

The outer shell 1 may have a soft touch exterior coating or may be constructed of a single flexible material such as silicone, for example.

The outer shell 1 has a large mobile device recess 14 for insertion of a mobile device such that when inserted, the mobile device's back, top, lower edge and sides are fully enclosed by the outer shell 1 except for a camera opening 2 on the back of the outer shell 1, and either separate buttons or openings on the sides or top for the power button 3, volume buttons 4 and mute/auxiliary button 5. FIG. 8 shows the device with a mobile device inserted in the mobile device recess 14.

The outer shell 1 incorporates buttons on the side or top for utilising the corresponding side or top buttons of the mobile device when inserted. These buttons may include the power button 3, volume buttons 4 and mute/auxiliary button 5, which may be either integrally moulded into the outer shell 1, separate pieces inserted into openings moulded in the outer shell 1, or small openings in the outer shell 1 to allow direct use of the buttons on the mobile device when inserted in the mobile device recess 14. The location of the power button 3, volume buttons 4 and mute/auxiliary button 5 is depicted in FIG. 3 and FIG. 4.

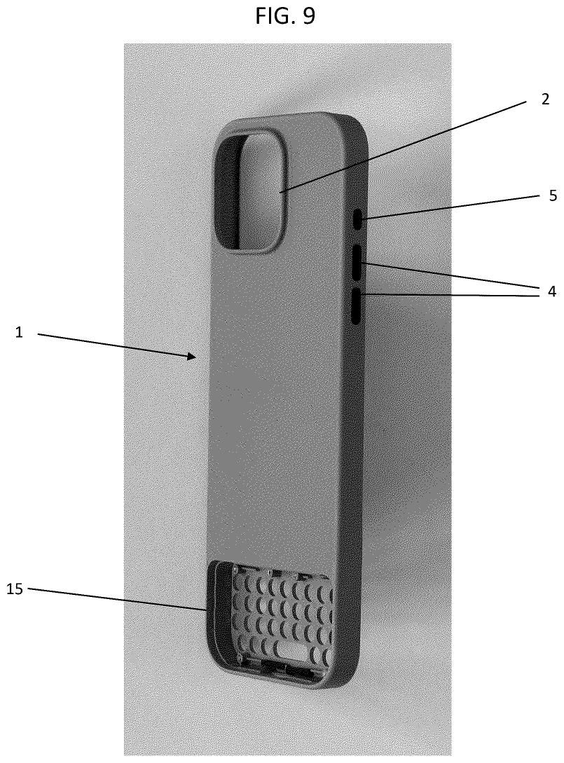

The front of the outer shell 1 has a collection of small openings for keyboard keys through which the upper key set 20 protrudes. The location of these keyboard key openings is visible in FIG. 9, and is shown with the protruding upper key set 20 in FIG. 8.

The back of the outer shell 1 has a subassembly cavity 15 for insertion of a keyboard subassembly 7 which is mounted inside the outer shell 1. FIG. 9 shows the location of the subassembly cavity 15 in relation to the outer shell 1. In the illustrated embodiment, the subassembly cavity 15 opens to the rear of the outer shell. But the invention is not limited in this regard. For example, the subassembly cavity 15 may open in any other direction, including opening into the mobile device recess 14.

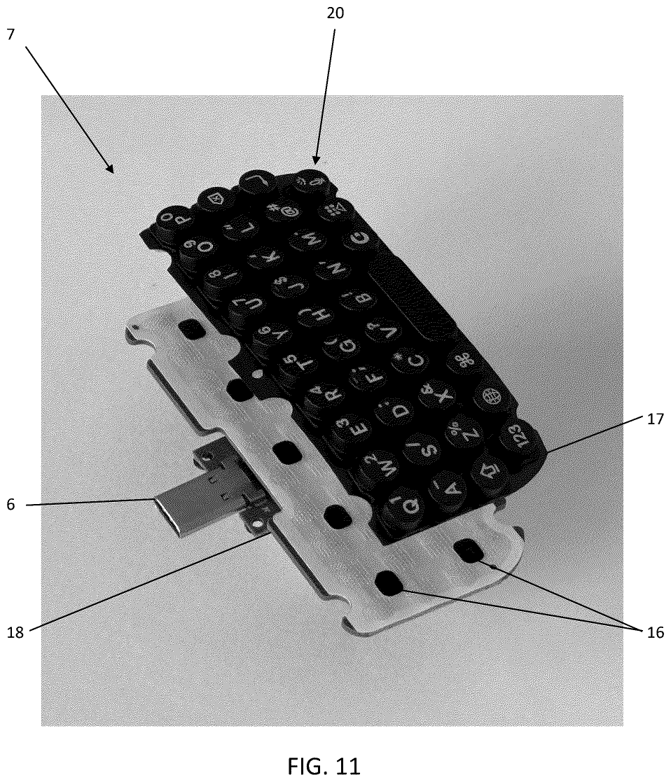

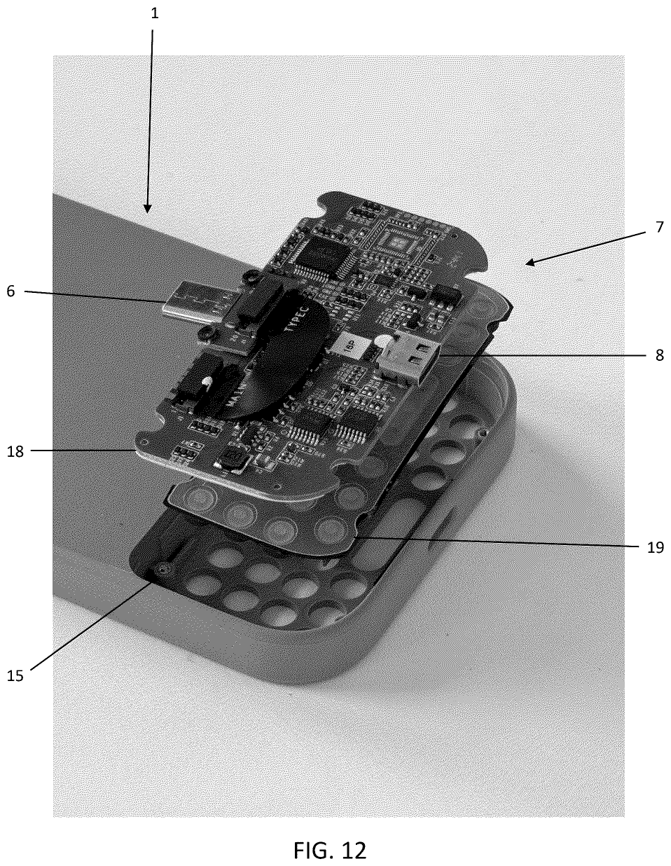

With reference to FIGS. 11 and 12, the keyboard subassembly 7 comprises an upper key set 20 of multiple individual keys which articulate independently of one another. Each individual key of the upper key set 20 contains lettering visible on its front face, except for the space bar key 10. The upper key set 20 is mounted on an opaque flexible keyboard base 17, to which a translucent layer 19 is bonded. The upper key set 20, flexible keyboard base 17 and translucent layer 19 sit together on top of an electronic circuit board 18. A cover (not illustrated) may be mounted on the outer shell 1 to protect the keyboard subassembly 7 mounted in the cavity 15. The cover may be fixed to the outer shell 1 in numerous and varied ways that are well known in this art. In alternative embodiments, the keyboard subassembly 7 may include an integrated frame, plug, or housing that fully encloses the subassembly cavity 15 when inserted into the outer shell 1. It will be appreciated that the keyboard subassembly 7 may be fully enclosed within the subassembly cavity 15 by way of injection moulding techniques, and other techniques that are well known in this art.

The electronic circuit board 18 comprises a male electronic connector 6, a female electronic connector 8, LED lighting with light shield 16 (see FIG. 11), a digital microprocessor chip, and an electronic circuit.

The digital microprocessor of the circuit board 18 controls the digital features of the device's functionality which may include keyboard backlighting, a power-saving sleep timer function, and which may be controlled by, and may interface with, software installed on a mobile device when inserted in the mobile device recess 14.

The design of the electronic circuit board 18 will be familiar to persons skilled in the art of electronic engineering with design ordered for the purposes of receiving electrical power from the mobile device via the male electronic connector 6, providing external keyboard functionality to the mobile device, providing user-programmable backlighting to the upper key set 20 by LED lighting behind light shields 16, registering keystrokes on a physical keyboard, transmitting data of registered keystrokes to the mobile device via the male electronic connector 6, transmitting electrical power received from an external power supply through the female electronic connector 8 to the mobile device via the male electronic connector 6, and transferring two-way data between the mobile device and an external data connection via the female electronic connector 8 and the male electronic connector 6.

When electrical power is supplied to the circuit board 18 via the male electronic connector 6, LED lighting on the front of the circuit board 18 illuminates the translucent layer 19, which in turn illuminates the lettered key faces of the upper key set 20, providing keyboard backlighting. The keyboard backlighting helps the device user to identify and distinguish the individual keys of the upper key set 20 especially in low light conditions.

In order to keep the light intensity of the keyboard backlighting homogenous across the entirety of the upper key set 20, opaque light shields 16 are located on the front side of the circuit board 18 immediately in front of each LED. The position of the light shields 16 is shown in FIG. 11.

FIG. 8 shows the device with a mobile device inserted in the mobile device recess 14, demonstrating the location of the upper key set 20 below the mobile device's screen. This arrangement allows the device user to make use of 100% of the screen surface area because none of the screen area is occupied by an on-screen digital keyboard. The device is only slightly wider and deeper than the mobile device itself, thereby preserving the slim and compact form factor of the device with a mobile device inserted, despite the additional vertical length to account for the addition of the keyboard subassembly 7.

The keyboard layout shown in FIG. 8 is arranged underneath the mobile device recess 14 with the mobile device oriented in a portrait arrangement. Compared with an alternative keyboard layout underneath a device oriented in a landscape arrangement, the portrait arrangement has the advantage of maximising mobile device utility because a significant number of popular software applications for mobile devices only support a portrait orientation of the mobile device, so software support is greater. Furthermore, the portrait arrangement allows for a convenient wired connection between the keyboard and the mobile device via the male electronic connector 6 being inserted into a female electronic connector of the mobile device, which is typically provided at the bottom side of the mobile device.

In FIG. 1 and FIG. 7, a male electronic connector 6 is shown protruding into the mobile device recess 14. This male electronic connector 6 is mounted directly onto the circuit board 18 and connects with a corresponding female electronic connector on the lower edge of the mobile device itself when inserted in the mobile device recess 14, thereby providing a means of transfer of keystroke data, electrical power and other data transfer to and from the mobile device. The connector 6 is a USB type C male electronic connector, though alternative multifunction connectors may be substituted in its place to match the connector found on the applicable mobile device.

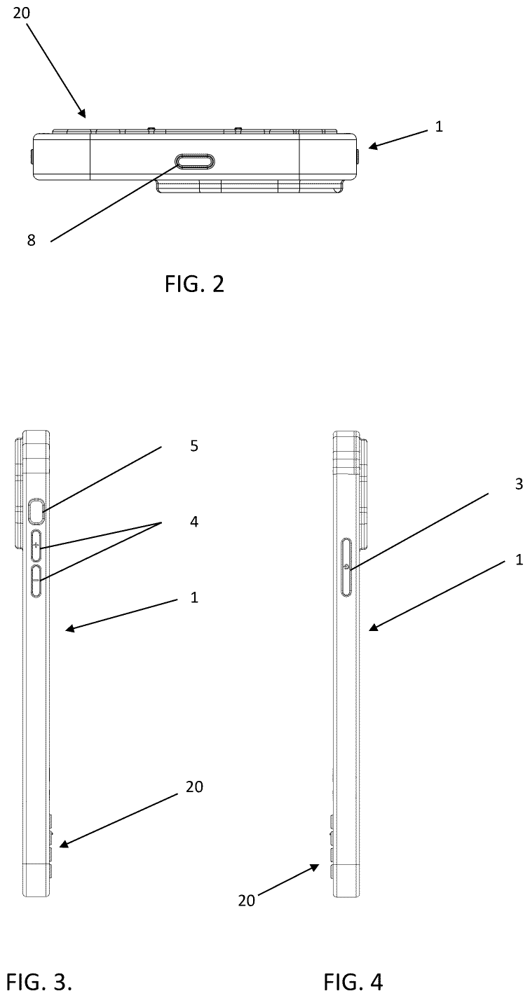

FIG. 2 shows the location of a female electronic connector 8, positioned on the lower edge of the circuit board 18. This female electronic connector 8 is mounted directly on the circuit board 18 itself and provides a means of supplying external electrical power and external data transfer to and from a mobile device when inserted in the mobile device recess 14, thereby allowing passthrough charging of the mobile device from an external power supply. The female electronic connector 8 is a USB type C female connector, though alternative multifunction connectors may be substituted in its place.

The outer shell 1 contains two small audio apertures 13 on the lower edge of the mobile device recess 14 which permit sound waves to travel to and from an inserted mobile device's microphone and loudspeaker located on its lower edge, enabling normal acoustic use of the mobile device when inserted. The location of the audio apertures 13 is shown in FIG. 1.

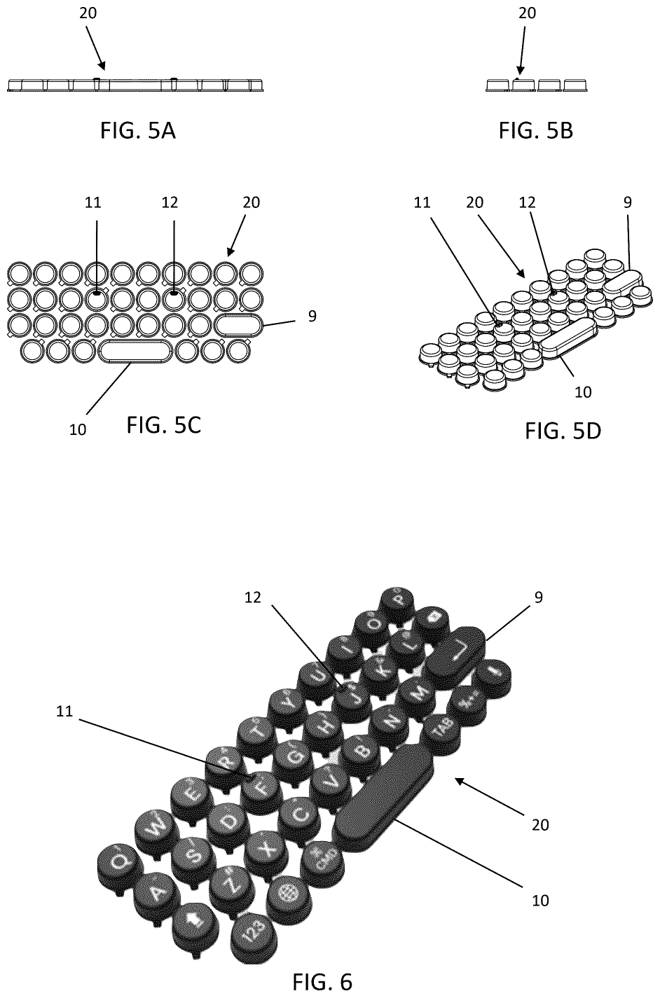

The device's upper key set 20 comprises thirty-six or thirty-seven individual keys. The arrangement of the individual keys of the upper key set 20 is designed to emulate a conventional keyboard format often used on laptop computers and on-screen mobile device keyboards so as to provide instant familiarity and ease of use for the device user. The upper key set 20 is located vertically below the mobile device screen when fitted in mobile device recess 14, enabling the use of alphanumeric physical typing keys with independent keys for each primary letter or character. The lettering of the upper key set may be arranged in a conventional ‘QWERTY’, ‘AZERTY’ or other common keyboard layout. The arrangement and proportions of the upper key set 20, including the enter key 9 (if applicable) and space bar key 10 are depicted in FIG. 5 and FIG. 6. The keyboard is arranged in four horizontal rows of keys, containing ten keys in both the first and second rows, nine or ten keys in the third row, and seven keys in the fourth row. The first two rows contain cylindrical keys with a circular cross section. The third row may contain either ten cylindrical keys, or eight cylindrical keys and one elongated enter key 9 (if applicable) with a pill-shaped cross section. The fourth row contains six cylindrical keys bisected by a wider central space bar key 10 with a pill-shape cross section in the middle of the fourth row, with three cylindrical keys positioned either side of the space bar key 10. Except for the enter key 9 (if applicable), the first three horizontal rows of keys are arranged in a grid style layout with each adjacent key displaced directly in either the horizontal or the vertical axis from its adjacent keys. The fourth row of keys is horizontally displaced relative to the row immediately above it, and arranged in a near-isometric layout such that, with the exception of the fourth-row keys, the centre of each cylindrical key of the fourth row sits equidistant from the centres of the two circular keys adjacent to it in the row immediately above.

The front surface of the keys of the upper key set 20 may be flat, concave or convex. The key surfaces of the upper key set 20 may be arranged in a single flat plane parallel to the front face of the outer shell 1 or may be tilted slightly towards their nearest sides of the outer shell 1.

Notwithstanding their lettering, all cylindrical keys of the upper key set 20 are homogeneous in size and shape except for the keys labelled ‘F’ 11 and ‘J’ 12 which contain additional protrusions for locating their position on the upper key set 20 to assist with accurate typing and fast key finding. FIG. 5 and FIG. 6 identify the locations of the F key 11 and the J key 12. A small gap separates all keys of the upper key set 20, and the key separation is consistent across the entire upper key set 20 without exception. Where the third row of keys has nine instead of ten keys, the enter key 9 is the same vertical height as the cylindrical keys, but displaces the aggregate horizontal width of two cylindrical keys, including the gap elsewhere found between two cylindrical keys, such that the widest point of the enter 9 key is identical to the outermost widest points of two adjacent cylindrical keys. The space bar key 10 is the same vertical height as the cylindrical keys, but occupies the aggregate horizontal width of three cylindrical keys plus the two gaps elsewhere found between three cylindrical keys such that the widest point of the space bar key 10 is identical to the outermost widest points of three adjacent cylindrical keys. The upper key set 20 is reflectively symmetrical in the device's central vertical axis save and except in the case of keyboard layouts comprising a third row with nine keys wherein the width of the enter key 9 at the far right end of the third row is larger and occupies the width of any other adjacent two cylindrical keys found elsewhere in the upper key set 20.

The individual keys of the upper key set 20, as depicted in FIGS. 5, 6, and 11, are mostly of a circular cross section when viewed from the front of the device (with the exception of the enter key 9 (if applicable) and the space bar key 10 which are elongated in the horizontal plane, as well as the F key 11 and J key 12 which contain the additional locating protrusions on their upper edge), but three-dimensional in profile insofar as that they present in a concave, convex or flat profile on the protruding front surface which contacts the user's finger. This shape of the front surfaces of the keys of the upper key set 20 are designed to ensure easy key finding and accurate typing due to the recognisable protrusions from the face of the device which can be felt when holding the device whilst in use. The protrusion of the upper key set 20 beyond the face of the outer shell 1 will be appreciated with reference to FIGS. 2-4. The keys of the upper key set 20 are less flexible than the flexible keyboard base 17 and translucent layer 19.

All keys of the upper key set 20, including the enter key 9 (if applicable) and the space bar key 10, have an identical vertical displacement of key travel when pressed. FIGS. 10 and 11 illustrate an alternative embodiment in which the elongated enter key 9 has been replaced with two additional cylindrical keys homogenous in shape with the remainder of the keys with the exception of the space bar key 10.

FIG. 6 illustrates the lettering of the cylindrical keys on the upper key set 20, each of which contains one primary character or symbol representing its main computing function. The majority of the keys on the upper key set 20 also contain a second smaller character or symbol in superscript above the primary key lettering, representing their secondary computing function.

With a mobile device inserted in the mobile device recess 14, as depicted in FIG. 8, the entirely of the mobile device's screen surface area remains visible to the user whilst typing, thereby enabling the user to avoid minimizing or deselecting the mobile device's on-screen keyboard, using the device's physical keyboard in its place instead, and retaining the full use of the mobile device's available screen area for other functions or utility whilst typing.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

INDEX - LIST OF LABELLED FEATURES IN DRAWINGS:

| NUMBER | FEATURE |
|---|---|
| 1 | outer shell |
| 2 | camera opening |
| 3 | power button |
| 4 | volume buttons |
| 5 | mute/auxiliary button |
| 6 | male electronic connector |
| 7 | keyboard subassembly |
| 8 | female electronic connector |
| 9 | enter key |
| 10 | space bar key |
| 11 | F key |
| 12 | J key |
| 13 | audio apertures |
| 14 | mobile device recess |
| 15 | subassembly cavity |
| 16 | light shield |
| 17 | flexible keyboard base |
| 18 | circuit board |
| 19 | translucent layer |
| 20 | upper key set |

What is claimed is:

1. A device for adding a keyboard to a mobile device, comprising:
an outer shell;
an open recess provided in the outer shell for insertion of the mobile device;
a keyboard attached to the outer shell;
wherein the outer shell is of a unibody single-piece construction.

2. The device according to claim 1, wherein the open recess faces a user when the mobile device is inserted, such that the user can interact with a main touchscreen of the mobile device.

3. The device according to claim 1, wherein the open recess and the keyboard face in the same direction.

4. The device according to claim 1, wherein the keyboard is mounted in a cavity provided in the outer shell.

5. The device according to claim 4, wherein the cavity and the open recess are spaced apart from each other.

6. The device according to claim 4, wherein the keyboard is operatively connected to a circuit board that is mounted in the cavity.

7. The device according to claim 6, wherein the keyboard and the circuit board form a sub-assembly that is inserted into the cavity.

8. The device according to claim 7, wherein the sub-assembly is a stacked arrangement comprising:
a light emitting diode mounted on and operatively connected to the circuit board;
a translucent sheet of flexible material stacked on top of the circuit board, such that that the light emitting diode is situated between the circuit board and the translucent sheet of flexible material;
an opaque sheet of flexible material stacked on top of the translucent sheet of flexible material, the opaque sheet of flexible material including light transmission areas that allow light transmission; and
a plurality of keys mounted on the opaque sheet of flexible material and respectively superposed above the light transmission areas.

9. The device according to claim 8, further comprising a male electronic connector that extends from the circuit board and into the open recess of the outer shell;
wherein the male electronic connector is configured to be inserted into a female electronic connector of the mobile device.

10. The device according to claim 9, further comprising a female electronic connector that extends from the circuit board an opens to an exterior of the outer shell.

11. The device according to claim 10, wherein the circuit board comprises:
a digital microprocessor configured to
control functionality of the circuit board,
interface with the mobile device via the male electronic connector, and
be controlled by the software on the mobile device; and
an internal electronic circuit configured to
receive electrical power from the mobile device via the male electronic connector,
activate the light emitting diode to illuminate backs of the plurality of keys,
transmit pass-through charging of the mobile device from a power supply connected to the female electronic connector, and simultaneously supply power directly to the mobile device via the male electronic connector,
register keystrokes from the keyboard, and
transmit data of registered keystrokes to the mobile device.

12. The device according to claim 1, wherein the keyboard comprises:
a plurality of keys in a layout with thirty six keys arranged in four horizontal rows with each row containing ten, ten, nine, and seven keys respectively, with a top three of the rows arranged in a grid pattern;
wherein a central spacebar key is included in a bottom row of the layout; and
wherein the keys are circular or rounded keys having a convex upward facing surface.

13. The device according to claim 1, wherein the keyboard comprises:
a plurality of keys in a layout with thirty seven keys arranged in four horizontal rows with each row containing ten, ten, ten, and seven keys respectively, with a top three of the rows arranged in a grid pattern;
wherein a central spacebar key is included in a bottom row of the layout; and
wherein the keys are circular or rounded keys having a convex upward facing surface.
